(19) United States
(12) Patent Application Publication
(10) Pub. No.: US 2017/0110714 A1
(43) Pub. Date: Apr. 20, 2017

(54) Electrochemical deposition of refined lithium metal from polymer electrolytes

(71) Applicants: Katherine J. Harry, Berkeley, CA (US); Nicole Schauser, Berkeley, CA (US); Nitash P. Balsara, El Cerrito, CA (US)

(72) Inventors: Katherine J. Harry, Berkeley, CA (US); Nicole Schauser, Berkeley, CA (US); Nitash P. Balsara, El Cerrito, CA (US)

(73) Assignee: The Regents of the University of California, Oakland, CA (US)

(21) Appl. No.: 15/294,703

(22) Filed: Oct. 15, 2016

Related U.S. Application Data
(60) Provisional application No. 62/242,784, filed on Oct. 16, 2015.

(51) Int. Cl. H01M 4/04; C25D 5/00; H01M 10/0565; H01M 4/134; H01M 4/38; H01M 4/66; C25D 3/54; H01M 10/0525

(52) U.S. Cl. CPC H01M 4/0457; C25D 3/54; C25D 5/00; H01M 10/0525; H01M 4/134; H01M 4/382; H01M 4/661; H01M 10/0565; H01M 2300/0082

(57) ABSTRACT

A method for electrochemical deposition of refined lithium metal to form a lithium anode in situ in a lithium (Li) ion battery comprising providing a fully lithiated cathode, providing a metal anode, providing a block copolymer electrolyte membrane between the cathode and the metal anode, and polarizing the cathode and the metal anode in the lithium ion battery to cause Li ions to migrate from the cathode through the block copolymer electrolyte and cause the electrochemical deposition to deposit refined lithium metal on the metal anode to form the lithium anode.

### CROSS REFERENCE TO RELATED APPLICATIONS

This application claims priority to U.S. Provisional Application Ser. No. 62/242,784 filed Oct.16, 2015, which application is incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

Field of the Invention

The present invention relates to the field of Lithium ion batteries.

Related Art

Lithium metal is a highly desirable anode material for applications requiring a high energy density battery due to its electropositivity and low atomic mass. Simply replacing the traditional graphite anode with lithium metal in a conventional lithium ion battery results in a significant increase in specific energy. Next generation battery chemistries, like lithium-sulfur and lithium-air, presume the use of a lithium metal anodes to achieve theoretical specific energies of 2458 Wh/kg and 5217 Wh/kg respectively. The theoretical specific energies of the sulfur and air battery chemistries fall to 572 and 939 Wh/kg if a traditional graphite anode is substituted for lithium metal. Given its importance in high energy density battery chemistries, there is strong motivation to understand the redox behavior of lithium metal.

Notably, lithium metal tends to form dendrites as lithium ions deposit on the lithium metal foil during battery charging. Lithium dendrites propagate through the electrolyte layer, and when they reach the cathode, the battery fails by short-circuit. This failure can be catastrophic if it occurs in the presence of a flammable electrolyte. Consequently, the use of lithium metal anodes with traditional liquid electrolytes is generally considered unsafe. Furthermore, liquid electrolytes form a mechanically unstable solid electrolyte interface (SEI) layer with lithium metal. This exacerbates lithium dendrite growth, resulting in premature battery failure. Polymer electrolytes, like poly(ethylene oxide), form a more stable SEI layer when cycled against lithium metal. Additionally, high molecular weight poly(ethylene oxide) is nonflammable unlike traditional carbonate-based liquid electrolytes. Therefore, polymer electrolytes are a promising candidate for enabling the safe use of the lithium metal anode.

Despite its improved stability toward lithium metal, dendrites still grow through poly(ethylene oxide) electrolyte membranes causing battery failure by short-circuit. Recent experiments have shown that the stability of the lithium metal anode is enhanced when a composite comprising co-continuous, nanoscale domains of rubbery poly(ethylene oxide) that conduct lithium ions and glassy polystyrene domains that provide mechanical rigidity is used as the electrolyte. These composites are conveniently obtained by self-assembly of polystyrene-b-poly(ethylene oxide) (SEO) block copolymers. Theoretical work by Monroe and Newman indicates that a stiff electrolyte results in smoother deposition of lithium because there is an energetic penalty associated with a reduction event in a region of high local strain. There is growing interest in understanding lithium deposition and dendrite growth through high-modulus electrolytes.

The goal of the present study is to expand our qualitative understanding of lithium deposition and stripping against rigid SEO block copolymer electrolytes.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1A-1C illustrates cross-section slices through reconstructed X-ray tomograms of a lithium metal, polymer electrolyte, lithium metal symmetric cell. FIG. 1A illustrates before the passage of current, the polymer electrolyte film is an unbroken membrane separating the two lithium metal electrodes. FIG. 1B illustrates after cycling, lithium-filled multi-globular structures form in the polymer electrolyte. FIG. 1C illustrates when lithium is passed in one direction, from the top to the bottom electrode, structures containing a single globule form. Additionally, ripples form as lithium is deposited unevenly on the bottom electrode.

FIGS. 2A and 2B illustrates X-ray tomograms showing globular structures short-circuiting the cell. FIG. 2A illustrates slices of a structure grown by passing ionic current in one direction as shown in FIG. 2E. FIG. 2B illustrates a side-view image of a structure grown after passing ionic current in both directions as shown in FIG. 5F. FIG. 2C illustrates top-view of the same structure shown in FIG. 2A. FIG. 2D illustrates a top view of the same structure shown in FIG. 2B. FIG. 2E illustrates the charging routine used to form the multi-globular morphology shown in FIG. 2A and FIG. 2C. FIG. 2F illustrates the charging routine used to form the globular morphology shown in FIG. 2B and FIG. 2D.

FIG. 3A illustrates a sequence of X-ray microtomography images showing the same location in cell E as a lithium globule grows and eventually punctures the polymer electrolyte membrane. The total amount of lithium transported through the electrolyte before failure by short-circuit corresponds to a 167 μm layer of lithium metal. FIG. 3B illustrates the cycling profile for cell E. The first image was taken after 17 preliminary cycles. At this time, a lithium globule had not yet begun to form in the position shown above. Times where the polarization was paused for imaging are denoted with an arrow. The three images shown in FIG. 3A correspond to the black arrows. Pauses are not shown for simplicity. The sample failed by short-circuit after about 9 days of active polarization.

FIG. 4A illustrates a SEM image of the lithium globule shown in FIG. 3A taken after disassembling the sample. This image is taken at a 52° angle. FIG. 4B illustrates a focused ion beam was used to mill into the globule revealing its cross-section. This scanning electron micrograph shows the same globule as shown in part a after milling. FIG. 4C illustrates the cross-section X-ray micrograph of the same globule. Only the upper tip of the globule was studied using SEM.

FIG. 5A illustrates a SEM image taken at a 52° angle of the cross-section of a multi-globular structure in cell 5 after milling with a FIB. FIG. 5B illustrates a blown up image of the region where energy dispersive spectroscopy was used to map the elements. FIG. 5C illustrates a map of the elements detected using energy dispersive spectroscopy. The absence of signal is interpreted to be lithium metal. The interior of the structure consists of lithium metal regions and regions containing elements from the electrolyte. These elements appear as the bright, X-ray absorbing electrolyte sacs surrounding lithium globules in X-ray microtomography images.

FIGS. 6A-6C illustrates morphology of defects in the deposited lithium electrode. Faceted impurity particles are located at the base of all defects. FIG. 6A illustrates a lithium globule. FIG. 6B illustrates a void. FIG. 6C illustrates a void with a globule on the top.

FIGS. 7A-7C illustrates reconstructed X-ray tomography slices. FIG. 7A illustrates unperturbed lithium metal. Bright impurity particles are embedded in the lithium foil. FIG. 7B illustrates electrochemically reduced lithium electrode devoid of visible impurity particles. The feature on the right is a grain boundary. Slice obtained 50 μm from the lithium/electrolyte interface. FIG. 7C illustrates electrochemically oxidized lithium electrode showing a high concentration of impurity particles. Slice obtained 10 μm from the lithium/electrolyte interface.

FIG. 8A illustrates a SEM image of the electrochemically reduced electrode covered with polymer electrolyte. The surface shows convex rippling. Two lithium globules are seen pushing through the polymer electrolyte. FIG. 8B illustrates a SEM image of the electrochemically oxidized electrode shows the corresponding impressions of the lithium globules as they pushed through the electrolyte. FIG. 8C illustrates higher magnification SEM images of the deposited lithium without an electrolyte cover shows grooving at the lithium grain boundaries. FIG. 8D illustrates impurity particles and grain boundary protrusions are visible on the higher magnification SEM image of the stripped lithium surface. All images are taken at a 52° angle.

FIGS. 9A-9B illustrate energy dispersive spectroscopy was used to identify the elements in an impurity particle stuck to the polymer electrolyte. The spectra in FIG. 9B for location 1 in FIG. 9A shows a large peak in intensity at an energy that corresponds to the oxygen K-edge. Location 2 shows peaks corresponding to the K-edges of carbon, oxygen, fluorine, and sulfur in FIG. 9B.

FIG. 10A illustrates a schematic showing a proposed mechanism for the nucleation and growth of a lithium globule, and FIG. 10B illustrates a schematic showing formation of voids.

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

These and other details and advantages of the present invention will become more fully apparent from the following description taken in conjunction with the accompanying drawings.

When the conventional graphite anode is replaced with lithium metal in rechargeable lithium ion batteries, the energy density of the battery increases significantly. However, the growth of electronically conductive structures, like lithium dendrites, from the lithium metal anode results in premature battery failure as the structures puncture the electrolyte causing a short circuit. High modulus electrolytes are theorized to suppress the growth of these structures by increasing the energy required for a lithium ion to reduce in regions of high local strain, like adendrite tip. The modulus of polymer electrolytes is readily tuned by creating a composite comprising co-continuous, nanoscale domains of rubbery poly(ethylene oxide) that conduct lithium ions and glassy polystyrene domains that provide mechanical rigidity. Furthermore, polymer electrolytes form a more stable solid electrolyte interface (SEI) with lithium metal and are less flammable than conventional liquid electrolytes. Therefore, there is considerable interest in studying the deposition and stripping behavior of lithium metal through these high modulus polymer electrolyte membranes.

We were hoping to achieve an understanding of how lithium metal is deposited from a polymer electrolyte. More specifically, we were interested in studying the influence of the polymer electrolyte modulus on the growth of lithium dendrites.

Before this discovery, little was known about the formation of the structures that cause battery failure by short circuit in polymer electrolytes. Since the existence of faceted impurity particles and their role in the formation of globular lithium structures was unknown, there has been no effort to remove faceted impurities from battery grade lithium metal foils.

While studying the deposition of lithium metal from a polymer electrolyte, we found that the structures that caused the cell to fail by short-circuit were globular, instead of dendritic, in nature. More importantly, in situ experiments show that these globular structures form on faceted impurity particles that are initially located at the lithium/electrolyte interface. While the impurities are uniformly distributed throughout the bulk of the lithium foil in initial images, the relative concentration of these impurities near the electrolyte changes as lithium is stripped from one electrode and deposited on the other. Notably, the deposited lithium is devoid of faceted impurities: the electrolyte acts as a filter for the lithium metal. One could use this electrolytic refining to prepare clean anodic lithium films for use in high energy density batteries with improved cycle life.

We are proposing a process by which our polymer electrolytes can be used to deposit lithium films that are devoid of faceted impurities. To our knowledge, this has not been done before.

The role of the faceted impurities (likely Li₂O) in the reduction of battery cycle life was unknown before these experiments.

The primary technical assumption that was overcome was understanding how the structures that cause batteries to fail by short circuit form from polymer electrolyte membranes. Once a connection was made between the formation of these structures and faceted impurity particles that are initially found in the lithium metal foils, one can try to imagine ways of eliminating the impurity particles. Conveniently, the lithium that is deposited from the electrolyte membrane is clean of the faceted impurity particles. Therefore, if one were to deposit a layer of lithium at a low current density, low enough to avoid the formation of lithium globules, then one would have a clean lithium film.

Additionally, because polymer electrolytes form a stable solid electrolyte interface (SEI) layer with lithium metal (and likely other reactive metals) the electrodeposition of metals from the polymer electrolyte is much smoother than that from traditional liquid electrolytes.

### Experimental

A 240-260 kg/mol polystyrene-b-poly(ethylene oxide) copolymer was synthesized via anionic polymerization as described previously (29, 30). This polymer self-assembles into a lamellar morphology with a domain spacing of 241 nm. The polydispersity index is 1.26 and the volume fraction of ethylene oxide is 0.50 without salt. Lithium metal foil was purchased from FMC Lithium at 99.9% purity. The foil thickness was 150 μm. All sample preparation was performed in a glovebox filled with 99.999% pure Argon gas. The oxygen and water levels were controlled and remained below 5 ppm.

### Electrolyte Preparation

Freeze-dried polymer electrolyte was mixed with lithium bis(trifluoromethane)sulfonamide salt (LiTFSI) at a concentration of 0.085 Li⁺ to ethylene oxide moieties and dissolved together in anhydrous N-Methyl-2-pyrrolidone (NMP). The polymer and salt solution was cast onto nickel foil and smoothed using a doctor blade. After allowing the membrane to dry on the casting plate at 60° C. overnight, tweezers were used to peel the polymer electrolyte membrane from the nickel foil. The free standing film was allowed to dry further under vacuum at 90° C. overnight. The thickness of the polymer electrolyte membrane was measured using a micrometer and was 30 μm thick.

### Sample Preparation for Ex Situ, Post Mortem X-Ray Tomography

Symmetric lithium-polymer electrolyte-lithium samples for post mortem X-ray tomography imaging were assembled using the following technique. A ½ inch diameter metal punch was used to cut a disc from the polymer electrolyte membrane. A 7/16 inch diameter metal punch was used to cut two lithium metal electrodes from a roll of lithium metal foil. The polymer electrolyte disc was sandwiched between the two lithium metal electrodes. Nickel tabs were placed on the two electrodes and the samples were vacuum sealed in aluminum pouch material lined with polypropylene and nylon. The sealed sample was removed from the glovebox and annealed at 120° C. in an oven overnight. After cycling, the sample was brought back into the glovebox for disassembly. The pouch material was removed and a ⅛ inch diameter punch was used to cut out only the central portion of the sample. This ⅛ inch diameter portion of the sample was vacuum sealed in pouch material and removed from the glovebox for imaging. This procedure was used to make samples A, B, C and D.

### Sample Preparation for In Situ, Stop-Motion X-Ray Microtomography Imaging

A ½ inch diameter metal punch was used to cut a polymer electrolyte disc from the previously cast electrolyte film. Three layers of lithium metal foil were stacked on top of a piece of nickel foil. The lithium electrodes were made by using a 7/16 inch punch to punch through the three layers of lithium and nickel foil backing. The thick lithium metal electrodes are necessary to prevent artifacts from the highly X-ray absorbing nickel foil from obscuring features near the lithium/electrolyte interface. The lithium was backed with nickel foil because most other metals, including aluminum, are known to react with lithium metal. The two, 450 μm thick lithium electrodes were used to sandwich the polymer electrolyte membrane. A 0.57 mm stainless steel shim was placed beneath the cell and a 0.35 mm shim was placed above the cell to keep it flat. Aluminum current collector tabs were then affixed to the stainless steel shims and the sample was vacuum sealed in pouch material. This procedure was used to make sample E.

The aluminum current collectors were relatively X-ray transparent, so the 22 keV X-ray beam was able to transmit through the current collectors and pouch material to reveal features at the lithium/electrolyte interface. The bottom stainless steel shim was thicker than the top shim so that the lithium/electrolyte interfaces are raised above the plane where the pouch material was sealed. This feature is needed to obtain clear reconstructed volumes as the sealing material through which the X-ray beam travels is minimized. An aluminum grid was placed on top of the pouch to help aid in identifying the positions where lithium globules were growing into the electrolyte. Once these positions were identified, they were marked and a higher magnification lens with a smaller field of view was used to image these positions.

The cell described above was used for in situ X-ray tomography experiments wherein charge was passed during imaging. In this study however, we focus on the growth of lithium globules through block copolymer electrolytes, a process that occurs on the time-scale of days. Due to limited access to the X-ray tomography beamline, we present results from stop-motion experiments wherein cells were cycled prior to beamtime, imaged, and returned to the cycling apparatus.

### Cycling Procedure for Post Mortem Samples

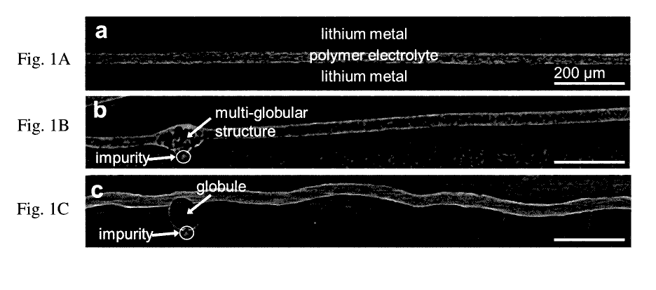

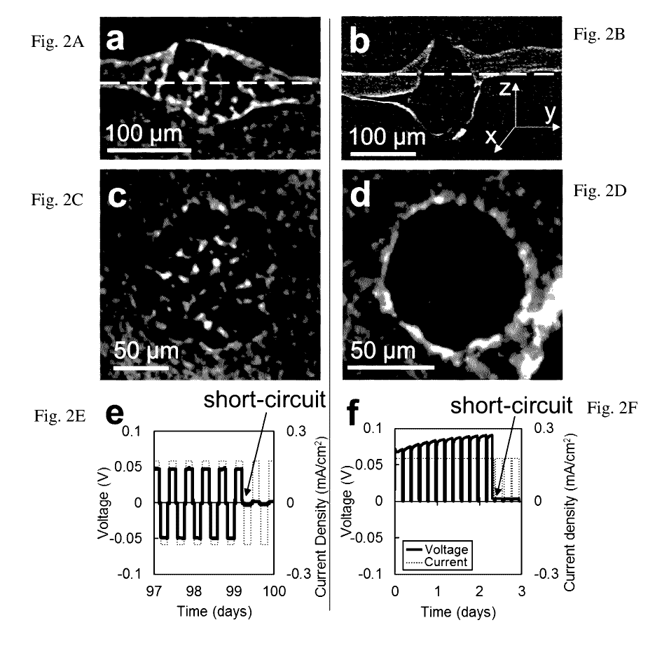

The sample shown in FIG. 1a was imaged shortly after assembly and was never cycled. The sample shown in FIGS 1b and 2b and d was cycled on a VMP3 potentiostat test system in a 90° C. oven using the following routine. First a 0.175 mA/cm² of current for four hours followed by a 45 minute rest. Next a −0.175 mA/cm² current was passed through the cell for four hours followed by a 45 minute rest. This routine was repeated until the sample failed by short-circuit. The sample shown in FIGS. 2a and 2c was cycled using the above routine 15 times, then charge was passed in only one direction for 47 hours when it failed by short-circuit.

### Cycling Procedure for In Situ Sample

The sample for in situ imaging was initially cycled 17 times using the previously described cycling routine. After these preliminary cycles, the sample was imaged using X-ray microtomography. Charge was then passed in a single direction at a current density of 0.175 mA/cm² for 4.5 hours. The sample was then removed from the oven and brought to the beamline for imaging. This was repeated until reconstructed volumes were collected at fourteen time points. At this point, charge was allowed to pass in the same direction for 31 hours before imaging. Since the sample still had not failed by short-circuit, charge was allowed to pass through the sample for another 114 hours when it finally failed. The sample was then brought back to the beamline for final imaging. Reconstructed volumes were collected at sixteen total time points.

The in situ experiment that we focus on in this paper was carried out over a period of 16 months. There were several months over which the sample was at rest at room temperature in the laboratory. The measured voltage across the sample varied by as much as 0.05 V after prolonged rest periods, or when the cycling equipment was changed, or the sample was repaired (for instance when the tabs broke in the middle of our study and the sample was repouched). We do not know what caused this; typical uncertainties in measured voltage of different cycling equipment available in our laboratory is 0.02 V.

### X-Ray Microtomography Imaging Parameters and Procedure

At the beamline, the stop-motion samples were imaged using an X-ray energy of 22 keV. Lenses with magnifications corresponding to image pixel sizes of 3.2 μm and 1.3 μm were used to image the sample. The lower magnification lens provided a larger field of view. Once the lithium globules began to grow, the higher magnification lens was used to image smaller regions of the sample. A table showing the beam current, beam energy, exposure time, and other scanning parameters for each image in the stop-motion sequence is given in Table 1. The ex situ samples were imaged at 20 keV using an exposure time of 350 ms.

TABLE 1

| | Ring | Beam | Number | Exposure | Rotation |
|---|---|---|---|---|---|
| Image | Current | energy | of | time | angle |
| Number | (mA) | (keV) | angles | (ms) | range |
| 1 | 500 | 20 | 1025 | 350 | 180 |
| 2 | 500 | 20 | 1025 | 350 | 180 |
| 3 | 500 | 20 | 1025 | 450 | 180 |
| 4 | 500 | 20 | 1025 | 350 | 180 |
| 5 | 500 | 20 | 1025 | 300 | 180 |
| 6 | 500 | 20 | 1025 | 300 | 180 |
| 7 | 500 | 20 | 1025 | 300 | 180 |
| 8 | 500 | 20 | 1025 | 1000 | 180 |
| 9 | 35 | 22 | 2049 | 1500 | 360 |
| 10 | 35 | 22 | 2049 | 1500 | 360 |
| 11 | 35 | 22 | 4097 | 1500 | 360 |
| 12 | 35 | 22 | 4097 | 1500 | 360 |
| 13 | 34 | 22 | 4097 | 1500 | 360 |
| 14 | 35 | 22 | 4097 | 1500 | 360 |
| 15 | 33 | 22 | 4097 | 1500 | 360 |
| 16 | 500 | 22 | 2049 | 600 | 180 |

### SEM and FIB

After cycling and X-ray imaging, the samples were brought back into the glovebox for disassembly. The pouch material was removed and the samples were submerged in a 10:1 solution of anhydrous benzene and anhydrous tetrahydrofuran heated at 40° C. and stirred at 300 rpm for 10 hours to dissolve the polymer electrolyte. At this point, tweezers were used to gently pull the two electrodes apart. Much of the polymer electrolyte remained stuck to the lithium electrodes. The samples were removed from the solution and allowed to dry under vacuum in an antechamber for a few minutes. The samples were then transferred to the SEM in a dessicator. The samples were exposed to air for less than 20 seconds upon transferring them from the desiccator to the SEM vacuum chamber. The samples were imaged using 10 keV electrons and a beam current of 10 μA. A20000 pA gallium ion beam was used to mill a trench through a lithium globule. After milling out a large enough area to see the globule cross-section, a 3000 pA gallium ion beam was used to polish the cross-section.

### Results and Discussion

This paper is based on five cells that we label A, B, C, D and E. The experiments performed on these cells are summarized in Table 1. We begin by describing the results of ex situ cycling. Our main objective is to study the growth of lithium globules in cells that were polarized by the application of dc current passed primarily in one direction (cells D and E). For simplicity, we refer to these as polarized cells. The digital cross section slices through reconstructed X-ray volumes of cells A, B, and D shown in FIG. 1 are representative examples of cross sections through uncycled, cycled, and polarized cells. The uncycled cell is devoid of any noteworthy features (FIG. 1a). Structures comprising several agglomerated globules of lithium appear in cycled cells (FIG. 1b). We refer to these structures as multi-globular structures. The dark regions of the globular structure are lithium globules surrounded by a sac that we tentatively call the “electrolyte sac.” The reason for this term will be clarified shortly. Samples that have failed by short-circuit typically contain one globular structure like the one shown in FIG. 1b that spans the electrolyte (and several others that do not span the electrolyte). All globular structures exhibit impurity particles that lie at the base. The formation of a globule on one electrode does not appear to stimulate the growth of a globule from the opposite electrode in a position directly across the electrolyte. The occurrence of two globules growing toward each other from both electrodes is rare. The morphology of globular structures described above are consistent with previous publications. In FIG. 1c we show an X-ray tomography digital slice through a polarized cell (cell D). Here we see one globule with an electrolyte sac and an impurity at the base. The thickness of the lithium layer transported across the electrolyte is 40 um for cell D. While this results in undulatory lithium/electrolyte interfaces, the macroscopic distance between the lithium electrodes is more or less constant at all points except those in the vicinity of the globular structure. The characteristic length scale of the undulations is about 300-400 μm, and the lithium/electrolyte interface is convex on the deposition side and concave on the stripping side. Notably, in both cycled and polarized cells (FIGS. 1b and 1c) a large portion of the electrolyte layer thickness is identical to that in the uncycled cell (FIG. 1a). In cycled cells, 0.2% of the lithium/electrolyte interface is occupied by multi-globular structures, while in polarized cells 0.5% of the interface is occupied by the structures. These values were obtained by examining xy slices through the lithium/electrolyte interfaces (eg. FIGS. 2c and 2d).

In the literature, structures that short cells with lithium metal electrodes are assumed to be dendritic. In many studies, images of dendritic structures have been presented. The structures obtained in our study bear no resemblance to classical dendritic structures which have sharp tips and are highly branched. In contrast, the globular structures obtained in our study are blunt and not branched. We therefore do not use the term dendrite to describe the globular structures observed in this study.

FIG. 2 shows a close-up image of the globular structures formed in cycled (FIGS. 2a and 2c) and polarized (FIGS. 2b and 2d) cells. FIGS. 2a and b show cross sectional, digital slices through the yz plane. FIG. 2c and d show cross sectional digital slices through the xy plane at z-values indicated by the yellow dashed line in FIGS. 2a and 2b. The cycling profiles used to grow these structures are shown in 2e and 2f. The structure shown in 2a and 2c comprises many small lithium globules surrounded by electrolyte sacs that amass to form one large structure that punctures the polymer electrolyte membrane. The structure shown in FIGS. 2b and 2d consists of one large lithium globule encased in an electrolyte sac. The bright sac surrounds most of the egg-shaped globule. However, there are regions of the sac that appear broken, allowing for the passage of electronic current through the globule.

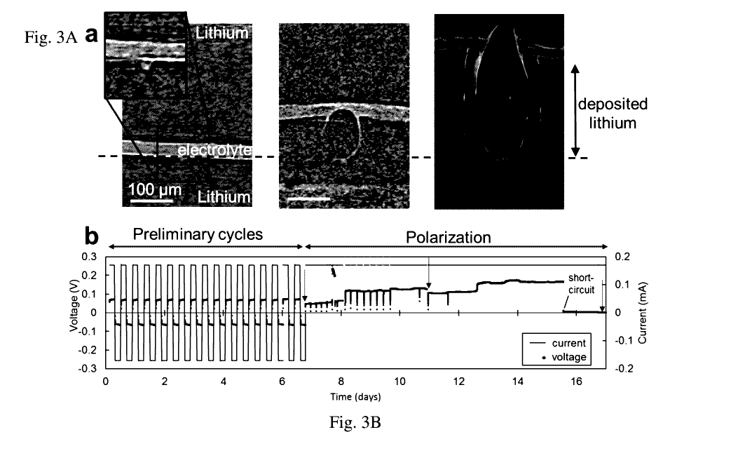

The sequence of tomograms shown in FIG. 3 show the results of an in situ experiment on cell E. These tomograms were obtained from the same location as lithium is stripped from the top electrode and deposited on the bottom electrode. After preliminary cycles, a small impurity particle is seen at the lower lithium/electrolyte interface (FIG. 3a). As lithium is deposited on the bottom electrode, the polymer electrolyte membrane moves upward. However, a disturbance occurs in the vicinity of the impurity particle and a globular structure like that shown in FIGS. 2b and 2d begins to form. Eventually, the structure grows large enough to puncture the electrolyte membrane. In this case, this occurs after a 167 μm layer of lithium is transported through the polymer electrolyte membrane. A sequence of sixteen reconstructed volumes was collected from this sample, but only three are shown for simplicity. The amounts of charge passed through cell E before the tomograms in FIGS. 3a, 3b, and 3c were obtained are 0, 55, and 124 C/cm²; we do not count coulombs passed during the preliminary cycling. Note that multiple globules were observed growing in this sample, however this is the only globule that appeared to puncture the electrolyte, causing the sample to fail by short-circuit.

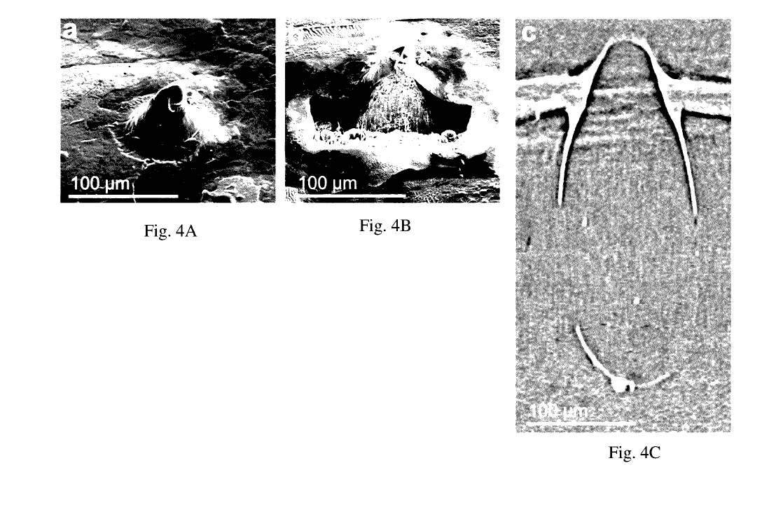

After cell E had shorted, it was disassembled for high-resolution imaging using scanning electron microscopy (SEM). Immersing the cell in 10:1 benzene to THF mixture separated the top electrode from the polymer and bottom electrode. An image of the surface of the polymer stuck to the bottom electrode, taken at a 52° angle from normal, is shown in FIG. 4a. This image shows a portion of the globule that protrudes into the space originally occupied by the top electrode. When the two electrodes were pulled apart, the globular structures remained lodged in the electrode where lithium was deposited. The position where the globule broke away from the top electrode is visible in the SEM micrographs (FIG. 4a). A focused ion beam (FIB) was used to mill a trench through the globule shown in 4a. The SEM image shown in 4b is of the same globule shown in FIG. 4a after FIB milling. The cross-section of the globule is revealed and matches that of the cross-sectional image taken using X-ray microtomography shown in FIG. 4c. In FIG. 4b, the large dome-like structure in the middle of the image is the lithium globule while the polymer electrolyte dominates the remainder of the image. Most of the globule is hidden within the bottom lithium electrode and is too deep to expose via FIB milling.

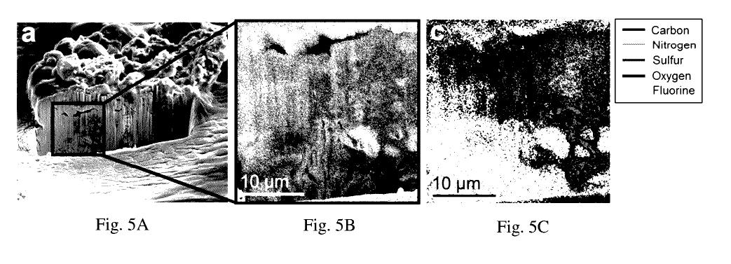

FIG. 5a shows an SEM image of the cross-section of a globule in cell C (a cycled ex situ cell) milled using the FIB. FIG. 5b shows a magnified view of the interior of a structure that contains multiple globules. The results of elemental mapping on the micrograph shown in FIG. 5b are shown in FIG. 5c. It should be noted that the sample could be imaged with the SEM and analyzed with EDS after FIB milling without removing the sample from the vacuum chamber. FIG. 5c is dominated by two regions: a colored region that contains elements found in the electrolyte and a white region where no signal is detected which we assume represents lithium metal. The EDS system used for these experiments was not capable of resolving lithium because of the low energy of the Li Kα x-rays. It is evident that the electrolyte is trapped within the interior of the multi-globular structure obtained during cycling. The extent to which the electrolyte trapped within this structure is degraded is not clear. The length-scales seen in FIGS. 5b and 5c are consistent with the length-scales of the globules and sacs seen in the X-ray tomograms (FIGS. 1b, 2a, 2c). We have thus established that the lithium globules in multi-globular structures are surrounded by electrolyte sacs.

The brightness of the features seen in the X-ray tomograms corresponds to the amount of X-rays absorbed by the elements contained in that feature. Since the electrolyte contains elements that are heavier than lithium, one would expect for the sacs surrounding the lithium globules to absorb more X-rays. This is consistent with the results shown in FIG. 5.

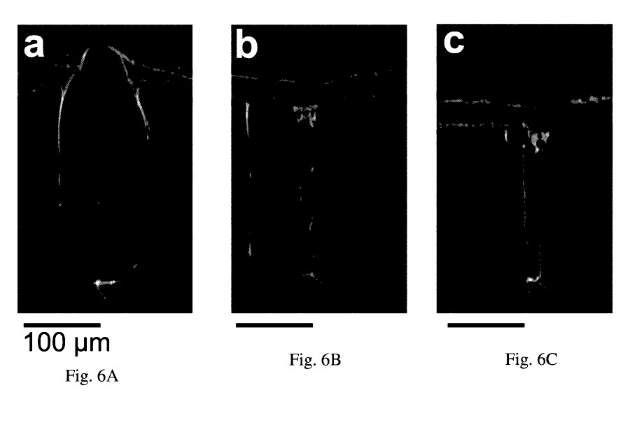

Having focused thus far on the globular structures, we turn our attention to the impurity particles. Other structures, in addition to the lithium globules, formed on top of impurity particles that were initially located at the lithium/electrolyte interface. In FIG. 6, we show examples of such structures seen in cell E at the end of the experiment (charge passed=124 C/cm²). A different globule from the one discussed previously is shown in FIG. 6a. A faceted impurity particle is located at the base of the globule. FIG. 6b shows a large void formed on top of the impurity particle. At the top of the void we see the beginnings of a lithium globule and another phase that appears to be degraded electrolyte. Note that after preliminary cycling, charge was passed in only one direction, so this void was formed by the lack of lithium deposition on the impurity particle rather than preferential stripping. FIG. 6c shows a different void formed on top of a faceted impurity particle. In this case, there is no evidence of a globular lithium structure forming on the void. To the left of the void we see a thin polymer streak. We show below that this occurs at grain boundaries. The prevalence of voids and globules that form on impurity particles is approximately equal (55% globules and 45% voids in cell E).

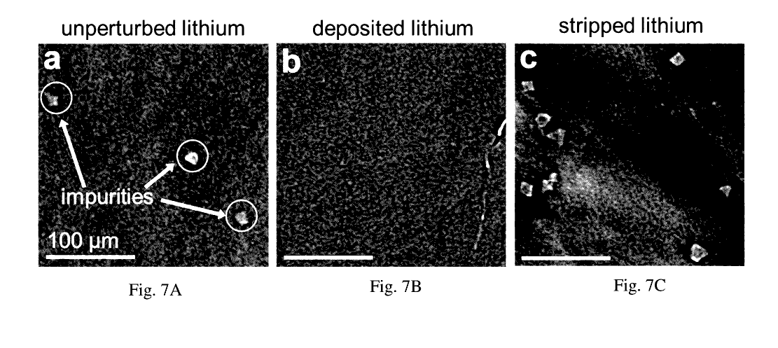

As lithium is stripped from the top electrode and deposited on the bottom electrode, the relative concentration of impurity particles changes. This is illustrated in FIG. 7 where three slices through cell E (charge passed=124 C/cm²) are presented. FIG. 7a shows a slice through an unperturbed region of lithium foil. We obtained this slice from the stripped electrode at a location 150 μm away from the lithium/electrolyte interface. The slice in FIG. 7a shows a relatively low concentration of faceted impurity particles. The particles are octahedral in shape and are generally about 20 μm from tip to tip. These particles are circled for clarity. FIG. 7b shows a slice through the deposited lithium layer (50 μm from lithium/electrolyte interface). We see no evidence of impurity particles in this slice. The feature on the right of the image is polymer trapped in a grain boundary. There were many slices of this size that were devoid of any features. FIG. 7c shows a slice 10 μm above the lithium/electrolyte interface on the stripped electrode. Here we see a high concentration of faceted impurity particles. The approximate concentration of impurity particles in unperturbed lithium foil is 880 particles/mm³. After electrochemical stripping, the impurity concentration increases sharply to 2400 particles/mm³ at the lithium/electrolyte interface. Notably, there are no impurities present in the layer of deposited lithium metal. Therefore, it is evident that the impurity particles are left behind as lithium is stripped from the electrode.

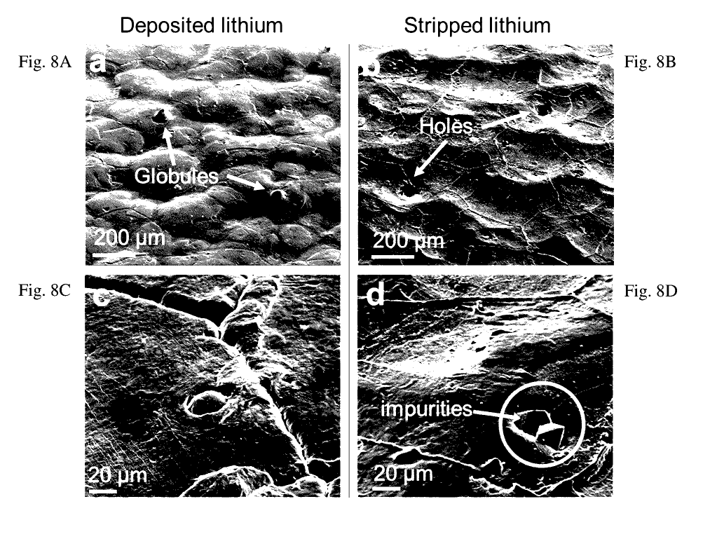

The SEM images shown in FIGS. 8a and b show the surface morphology of the two electrodes from in situ, polarized cell E. The regions shown here faced each other in the cell prior to disassembly. FIG. 8a shows the bottom electrode, where lithium was deposited, after disassembly. This electrode is partially blanketed with the polymer electrolyte in spite of the fact that the cell was soaked in a solvent that dissolves the block copolymer electrolyte. The entire region shown in FIG. 8a is blanketed with polymer, but there were other regions that were not blanketed. The tips of two globules are observed pushing through the electrolyte film. Convex ripples are observed on this electrode. FIG. 8b shows the top lithium electrode where lithium was stripped. Two indentations are seen in the top electrode corresponding to the positions where the tips of the lithium globules pressed up into the electrode. Concave ripples are seen on the surface of the stripped electrode. The stripped electrode appears to be an impression of the deposited electrode.

FIGS. 8c and 8d show higher magnification images of the deposited and stripped electrodes of cell E. FIG. 8c shows a region of the deposited electrode that was not blanketed by polymer electrolyte. The tip of a small globule can be seen in the center of the image. Grain boundary grooving is observed on this electrode indicating that lithium reduction at grain boundaries is slower than that on the crystal faces. FIG. 8d shows the surface of the stripped electrode. The grain boundaries protrude from this electrode surface, indicating that lithium is more readily oxidized from the crystal faces. The locations of the grain boundaries on the two electrodes are not correlated. The stripped electrode is littered with faceted impurity particles. Regions of the deposited electrode that were not blanketed by polymer showed no evidence of faceted impurities. Regions of the deposited electrode that were blanketed by polymer showed a few faceted particles. It is likely that these particles stuck to the polymer as the two electrodes were separated.

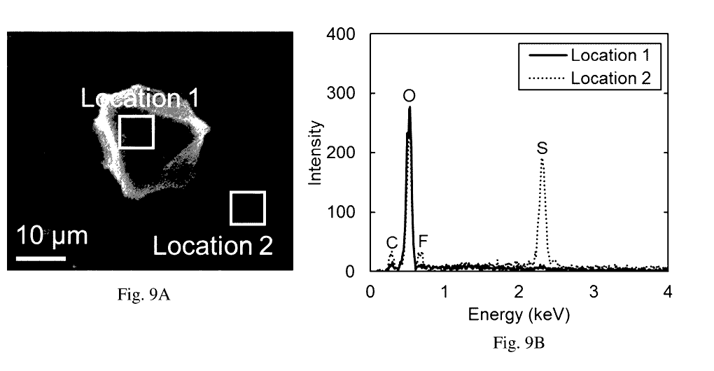

FIG. 9 shows energy dispersive spectroscopy (EDS) data from an impurity particle that was stuck to the polymer electrolyte in cell E. Spectra were collected for two locations within the sample. The first location is on top of the faceted impurity particle. This location shows a large intensity peak at 0.53 keV, associated with the oxygen K-edge. No other elements are detected in this region. The second location is on the polymer electrolyte film. The spectra collected at this location shows intensity peaks at energies that correspond to carbon, oxygen, fluorine, and sulfur. These elements are all components of the polymer electrolyte. The beam energy for these measurements was 15 keV. Generally, signal is obtained from elements in the top few micrometers of the region examined using EDS. Light elements like hydrogen, helium, and lithium are undetectable. Based on the spectra collected at location 1, the identity of the impurity particle is likely either lithium oxide (Li₂O) or lithium hydroxide (LiOH). Lithium oxide assumes an antifluorite crystal structure that tends to exhibit octahedral cleavage planes, consistent with the faceted shape of the impurity particles seen in this study. Further work is needed to systematically characterize the impurity particles.

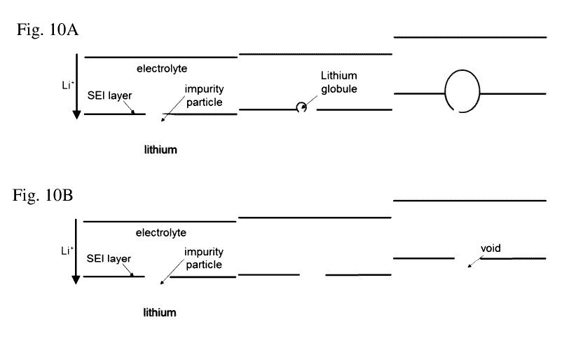

One hypothesis for the irregular deposition of lithium at these impurity particles is that the insulating nature of the particles prevent the reduction of lithium metal directly on top of the impurity due to the lack of access to electrons. Mechanisms by which this may result in the formation of globules and voids are presented schematically in FIG. 10. We assume the presence of a stabilizing solid electrolyte interface (SEI) layer between lithium metal and our electrolyte. The SEI layer is too thin for detection by X-ray microtomography. We posit that the SEI is interrupted at the edges of the impurity particle. This could lead to preferential lithium deposition at the corner of the impurity particle as shown in FIG. 10a due to an increase in local conductivity or concentration of electric field lines. On the other hand, a void may be generated on top of the impurity as shown in FIG. 10b. The corresponding tomograms through the voids (FIGS. 6b and 6c) show a bright phase at the top of the void. We propose that this is degraded polymer electrolyte with excess salt. Presumably, the polymer electrolyte on top of these particles could be more susceptible to side-reactions. As the lithium/electrolyte interface surrounding the impurity particle moves upward and the impurity particle remains adhered to the electrode at its original location, the degraded polymer separates from the surface of the impurity leaving a void.

Since the block copolymer electrolyte acts like a filter for the lithium metal, one could take advantage of this phenomenon to produce a clean layer of deposited lithium that is free of impurities. Using such a layer in a battery is likely to improve cycle life as we have demonstrated a relationship between the globules that short the cell and the impurities.

### Conclusion

We have used X-ray microtomography and SEM imaging to study lithium deposition and stripping in symmetric lithium-polymer-lithium cells wherein a rigid polystyrene-b-poly(ethylene oxide) block copolymer serves as the electrolyte. This enabled identification of lithium structures that caused cell shorting. When charge is passed in one direction, these structures consist of a single lithium globule encased in an electrolyte sac. When charge is passed in both directions, simulating the charge and discharge cycling experienced by full batteries, they consist of many small globules connected together as an agglomerate. In both cases, an impurity particle lies at the base of the structure. It is generally assumed that failure of lithium metal electrodes is due to the formation of dendrites, a highly-branched structure with pointed tips. The globular structures identified in this study are qualitatively different from dendrites; they are unbranched and rounded. Our work suggests that the growth of branched structures is thwarted by rigid electrolytes.

Stop-motion X-ray tomography was used to track the evolution of globules obtained when charge is passed in one direction. The impurity particles are rich in oxygen and electronically insulating. We hypothesize that ionic current is localized at the edge of the particles due to disruption of the SEI layer, resulting in the nucleation and growth of lithium globules. We also observed void formation on top of the particles, consistent with the fact that they are electronically insulating. When lithium is stripped from an electrode, the impurity particles are left behind, resulting in a high concentration of impurities in the oxidized electrode, particularly in the vicinity of the lithium/electrolyte interface. Conversely, the deposited lithium is devoid of visible impurities. Electrolytic refining of lithium metal using a block copolymer electrolyte could be used to prepare clean lithium foils for lithium metal batteries with improved cycle life.

TABLE 2

| Cell | Sample | Cycling | | |
|---|---|---|---|---|
| name | architecture | history | Imaging history | Figure |
| Cell A | Ex situ | Uncycled | X-ray microtomography | 1a |
| Cell B | Ex situ | Cycled | X-ray microtomography | 1b, 2b, 2d |
| Cell C | Ex situ | Cycled | SEM, FIB | 5 |
| Cell D | Ex situ | Polarized | X-ray microtomography | 1c, 2a, 2c |
| Cell E | In situ | Polarized | X-ray microtomography, | 3, 4, 6, 7, |
| | | | SEM, FIB | 8, 9 |

What is claimed is:

1. A method for electrochemical deposition of refined lithium metal to form a lithium anode in situ in a lithium (Li) ion battery comprising:
providing a fully lithiated cathode;
providing a metal anode;
providing a block copolymer electrolyte membrane between the cathode and the metal anode; and
polarizing the cathode and the metal anode in the lithium ion battery to cause Li ions to migrate from the cathode through the block copolymer electrolyte and cause the electrochemical deposition to deposit refined lithium metal on the metal anode to form the lithium anode.

2. The method of claim 1 wherein the block copolymer electrolyte membrane comprises a polystyrene-b-poly(ethylene oxide) (SEO) block copolymer.

3. The method of claim 1 wherein the metal anode comprises lithium metal.

4. The method of claim 1 wherein the metal anode comprises nickel metal.
